(19) United States
(12) Patent Application Publication
(10) Pub. No.: US 2018/0297471 A1
(43) Pub. Date: Oct. 18, 2018

(54) SUPPORT TO HANDLE AN OBJECT WITHIN A PASSENGER INTERIOR OF A VEHICLE

(71) Applicant: FORD GLOBAL TECHNOLOGIES, LLC, Dearborn, MI (US)

(72) Inventors: Frederic STEFAN, Aachen (DE); Uwe GUSSEN, Huertgenwald (DE); Christoph ARNDT, Moerlen (DE)

(73) Assignee: FORD GLOBAL TECHNOLOGIES, LLC, Dearborn, MI (US)

(21) Appl. No.: 15/951,453

(22) Filed: Apr. 12, 2018

(30) Foreign Application Priority Data
Apr. 12, 2017 (DE) 10 2017 206 312.2

(51) Int. Cl. B60K 35/00; B60Q 9/00; B60R 11/04; G02B 27/01

(52) U.S. Cl. CPC B60K 35/00; B60Y 2400/902; B60R 11/04; G02B 27/0179; G02B 27/0101; G02B 2027/014; G02B 2027/0141; G02B 2027/0187; G02B 2027/0138; B60R 2300/8006; B60R 2300/205; B60K 2350/2013; B60R 2300/105; B60K 2350/965; B60K 2350/901; B60Y 2400/92; B60Q 9/00

(57) ABSTRACT

The disclosure related to a system to support handling of an object located within a passenger interior of a motor vehicle and not connected to the motor vehicle. The system has a sensor unit to detect a distance of the object to a storage area available within the passenger interior. An evaluation unit receives and processes sensor signals generated by the sensor unit. A signaling unit that can be controlled using the evaluation unit to emit optic, acoustic and/or haptic signals within the passenger interior to determine if a hand of the driver moves towards the storage area and activate the signaling unit if the hand moves towards the storage area and if the hand is located, for a predetermined period of time, within the storage area of a predetermined size.

### CROSS-REFERENCE TO RELATED APPLICATIONS

This application claims foreign priority benefits under 35 U.S.C. § 119(a)-(d) to Application DE 10 2017 206 312.2 filed Apr. 12, 2017, which is hereby incorporated by reference in its entirety.

### TECHNICAL FIELD

The disclosure relates to a system and a method to support handling of an object located on the inside, and not connected to of a passenger interior of a motor vehicle

### BACKGROUND

In a passenger interior of a motor vehicle, various objects can be available that are not connected to the motor vehicle, which a driver of the motor vehicle can handle when driving the motor vehicle. For example, a driver, in particular, in the case of driving the motor vehicle for longer periods, may have the need to drink out of a beverage bottle or the like located in the passenger interior or to eat a solid food located in the passenger interior. The beverage bottle can, for example, be arranged on a central can holder. Furthermore, the driver may desire to handle an object located within the passenger interior, for example, a compact disc (CD).

In the case of the situations described, the driver grasps the respective object for a short time, whereby he/she initially grasps the object and takes it from a storage area and after the desired handling thereof, sets down/stores it again in the storage area. In order to grasp and store or set the object down, the driver must usually turn their view away from the street for a short period of time so that attentiveness of the driver is impaired, or the driver is distracted from a respective driving situation. Even if this distraction of the driver occurs over a relatively short period of time, the distraction can be very critical in a dangerous situation, for example, in the case of heavy braking of motor vehicle driving ahead, another motor vehicle trying to violently pass, a person, an animal or an object on the upcoming street, at an intersection or the like. Even if a driving assistance system is activated, it may be necessary for the driver to take control of the motor vehicle again or observe the driving assistance system information.

Various approaches are known from the most recent background art, by means of which distraction of the driver of a motor vehicle should be reduced.

DE 100 39432 C1 relates to an operating apparatus for distraction-free operation of switches in a motor vehicle. The operating apparatus comprises a sensor to detect a position of an input element that is manually operated by an operator, an optic display unit in the operator's field of vision for displaying at least one virtual operating element, an evaluation unit connected to the sensor on the input side to determine the position of the manually operated input element and an imaging device connected to the evaluation unit and to the display unit on the output side to display a virtual image indicator within the operator's field of vision corresponding to the position of the manually operated operating element.

DE 196 53 595 C1 relates to an information display system for at least one person, where an operating apparatus for the at least one person is placed in a well-accessible position but not necessarily within their field of view and where a display is placed in the natural direction of view. A video camera is set up on the operating apparatus and a picture is shown on the display taken by the video camera.

DE 10 2005 056 458 B4 relates to an operating apparatus for a motor vehicle with an operating unit, which comprises at least a manual operating element, at least one sensor unit, which detects a hand of the operator activating the at least one manual operating element and an optic display unit, which represents the operating unit as a user interface and display interface and the detected hand performing activation in the field of vision of the operator. The optic display unit indicates the detected hand performing the operation as a transparent image on the user and display interface in such a way that areas of the user and display interface concealed by the image are visible. A degree of transparency of the image can be adjusted depending on a determined distance of the hand from the operating unit.

EP 1 785 308 A2 relates to an in-car switch controller for a driver to control electronic apparatuses that are provided within a motor vehicle. The switch controller comprises: a switch arrangement with a plurality of switches, which are positioned near a driver's seat so that they can be easily operated by the driver; a camera that is arranged near the driver's seat and is designed to successively photograph an operating action of the switch arrangement and the switch activation of the driver; a display-image data-storage section, which is designed to store a plurality of display-image datasets. The datasets are used to display functions, which are assigned to the aforementioned switches respectively corresponding to the images. The images are photographed by the camera, in areas around the aforementioned switches. The switch controller also comprises an image synthesis section, which is designed to synthesize image data that belongs to the photographed image, and the display-image data, which is stored in the display-image data-storage section, into a single picture. The switch controller also comprises a display section that is positioned on a front dashboard or near the same being designed to display the synthesized image. A control section is designed to receive an operating signal, which is emitted by the aforementioned switches and emit a control signal to carry out the function that is assigned to the image of the aforementioned switch, which is shown in the aforementioned display section. The switch determines a set of display data for each type of apparatus to be controlled so that it corresponds to the display of the switch's image. The control section comprises a display-image data-determination device that is designed to receive an operating signal from the aforementioned switch in order to indicate the aforementioned display-image data-storage section to read image data in order to update the set of display-image data for the certain display-image dataset. The image synthesis section is designed to continuously receive image data, which is photographed by the CCD camera and receive display-image data each time the display-image data-storage section reads new image data. The image synthesis section is designed to update the synthesized image data each time the display-image data-storage section reads new image data.

WO 2007/029095 A1 relates to a motor vehicle control apparatus where a touch panel operation section, on which control switches are arranged and which has an upper surface., The upper surface, an operation is carried by a hand of a user that generates an operating signal, which corresponds to an operating position, is arranged in a motor vehicle cabin at a single location. The single location is physically at a distance from a display section, which displays an operating menu image. The operating menu image indicates the operating position arrangement and function of the control switch of the operation section. The motor vehicle operating apparatus comprises an image capturing means to capture images of the operation section and the hand of the user, a combining and display means to combine the captured image of the hand with the operating menu image and display the combined image on the display section, wherein the combining and display means carry out the combining and display by converting the image of the hand into a graphical image of the hand, combines the graphic image of the hand with the operating menu image and displaces the combined image on the display section. The motor vehicle operating apparatus comprises a light-emission means for illuminating the entire touch panel. The graphical image of the hand is generated by indicating an outline of the hand and by using a transparent or semitransparent color on an area within the outline of the hand.

### SUMMARY

It is the object of the disclosure to support a driver of a motor vehicle with handling an object, which is not connected to the motor vehicle and located within a passenger interior of the motor vehicle in such a way that the driver is distracted to the least amount possible by the respective driving process.

A system according to the disclosure to support handling of an object not connected to the motor vehicle and located within the passenger interior of a motor vehicle comprises: at least one sensor unit, which can be arranged on a motor vehicle. The sensor unit is set up to detect a distance of the object to at least one storage area available within the passenger interior and/or to detect at least one area of the passenger interior. The area of the passenger interior has at least one storage area to store at least one object. The system also comprises at least one evaluation unit that is set up to receive and process sensor signals generated by the sensor unit. The system also comprises at least one signaling unit that can be controlled using the evaluation unit, which is set up to emit optic, acoustic and/or haptic signals within the passenger interior. The evaluation unit is set up to determine from the sensor signals if a hand and/or an arm of the driver moves towards the storage area and/or if the hand and/or the arm of the driver is located within an environment comprising the storage area of a predetermine size of the storage area for a predetermined period of time. Furthermore, the evaluation unit is set up to activate the signaling unit if the hand and/or the arm of the driver moves towards the storage area and/or if the hand/or the arm of the driver is located within an environment comprising the storage area of a predetermine size of the storage area for a predetermined period of time.

During the detection of the hand and/or arm of the driver moving toward the storage area and/or if the hand/or the arm of the driver is located, for a predetermined period of time, within an environment comprising an area of a predetermined size of the storage area, the system according to the disclosure can deduce that the driver grasps an object positioned in the storage area and wants to take it in his/her hand or that he/she wants to set down or store the object located in his/her hand in the storage area. When grasping or setting the object down, the system according to the disclosure supports the driver by detecting or monitoring movement of the hand and/or the arm of the driver and generates signals emitted within the passenger interior, which can be perceived by the driver., The signals serve to give the driver a feeling to position his/her hand relative to the storage area. The driver does not have to look towards the storage area when grasping for or setting down the object. Instead, grasping or setting down the object can occur without looking in the direction of the storage area so that the attentiveness of the driver is impaired to the least extent possible or the driver is distracted by the respective driving process to the least extent possible.

The use of the system according to the disclosure is not limited to a certain area of the passenger interior. Using the sensor unit, for example, a driver can be detected directly around a surrounding area of the passenger interior, an entire front area of the passenger interior or the entire passenger interior. In addition, the system is not limited to monitoring of a certain hand or a certain arm of the driver. Instead, the system can be set up to detect the right arm or the right hand, the left arm or the left hand and/or both hands and arms of the driver.

In order to detect at least one area of the passenger interior, which has at least one storage area to store at least one object, the sensor unit may, for example, have at least one camera and/or be arranged in an upper area of the passenger interior, for example, on the motor vehicle headliner, on a rear-view mirror, on a grip element on the roof or the like. For example, the sensor unit can be arranged above the driver. The system according to the disclosure can also have two or a plurality of sensor units spaced away from one another so that the at least one area of the passenger interior can be detected without arranging any concealed areas to the furthest extent possible.

In order to support a process where an object is taken from the storage area in order to be used in any way and to support a process where a used object is added into the storage area, the sensor device can additionally be set up to detect a distance of the object during these processes to the at least one storage area available within the passenger interior. For this purpose, the object and/or the storage area can be equipped with at least one optic sensor, for example, a camera, at least one capacitive sensor, at least one ultrasound sensor, at least on radio-frequency identification (RFID) sensor, at least one Bluetooth sensor, at least one near-field communication (NFC) sensor or the like. Thereby, the distance between the object and the storage area can be captured very precisely, which can improve the system's accuracy.

The signaling unit is activated according to the disclosure when the driver moves his/her hand and/or his/her arm towards at least one storage area and/or when the driver holds his/her hand and/or his/her arm within the environment comprising the storage area of a predefined size for a predefined period of time. Since the signaling unit is thereby not continuously operated, the system according to the disclosure can be operated in a power-saving manner. When activated, external conditions, which can be detected via a driver assistance system of the motor vehicle, can be taken into account. If for example, the driver assistance system detects a dangerous situation, it can deactivate the system according to the disclosure or keep it deactivated. When driving the motor vehicle, the signaling unit is deactivated most of the time.

The evaluation unit can be designed by software implementation into the existing motor vehicle electronics or as a separate electronic unit. The evaluation unit can be connected to the sensor unit via a wire or in a wireless manner in order to be able to receive and process the sensor signals generated by the sensor unit. Due to the processing of the sensor signals, the evaluation unit is set up to determine from the sensor signals if the hand and/or the arm of the driver moves towards at least one storage area and/or if the hand and/or the arm of the driver is located within an environment comprising of at least one storage area of a predefined size and storage area. For this purpose, the evaluation unit can have an image processing algorithm, with which the hand or the arm of the driver and its position and movement can be detected.

Due to a movement of the hand and/or the arm of the driver towards the storage area, it can be determined that the driver would like to grasp an object located in the storage area or that the driver would like to set down or store an object located in his/her hand in the storage area. Thereby, the evaluation unit can determine a path of movement of the hand or the arm of the driver in order to be able to detect if the hand or the arm is moving towards the storage area. In addition, the evaluation unit can set up to detect a movement speed of the hand and of the arm in order to be able to deduce if the driver would like to grasp an object located in the storage area or if the driver would like to store or set down an object located in his/her hand into the storage area. Furthermore, the evaluation unit can provide support for the placement and storage of the object into the same storage area or in another storage area within the passenger interior.

The sensor unit can be set up to communicate with a transmission unit arranged on the hand and/or the arm of the driver or receive signals from the transmission unit in order to carry out the support according to the disclosure. The transmission unit can, for example, be designed using smart clothing, in particular a smart glove, with or without a gripping, power or supporting function or using a third electronic arm supporting the arm or the like. The smart clothing can be equipped with a unit to generate haptic feedback for the driver. Thus, the smart clothing can form a signaling unit of the system.

The signaling unit can, for example, have at least one display unit to emit optic signals, at least one loudspeaker to emit acoustic signals and/or at least one vibration unit to emit haptic signals within the passenger interior.

The storage area can, for example, be a storage location or a parking area. The storage area can, for example, be a beverage-bottle holder or the like. The storage area can be a storage compartment on the inside of the door, on the dashboard, on the center counsel on a component arranged between the front seats. The storage area can also be a retaining pocket arranged on a back side of a front seat or the like.

In accordance with an advantageous embodiment, the evaluation unit is set up to control an activated signaling unit in such a way that signals emitted from the signaling unit are varied depending on a distance of the hand and/or of the arm of the driver or the object to the storage area. From the differences in the signals or the variations of the signals, the driver can deduce if his/her hand or his/her arm is approaching the storage area or not. In the case of acoustic signals, for example, a pitch depending on the distance of the hand and/or the arm or the object to the storage area may vary. As alternative, the signaling unit can emit beeps at the same pitch, the time interval of which is varied depending the distance of the hand and/or the arm or the object to the storage area. Alternatively, the signaling unit can generate acoustic signals in the form of a voice output in order to support the driver in his/her endeavors. In the case of haptic signals, for example, a vibration of a signaling object of the signaling unit may be varied depending on the distance of the hand and/or the arm or the object to the storage area. As an alternative, the signaling unit can emit vibration impulses at a constant strength, a time interval of which is varied depending on the distance of the hand and/or the arm or the object to the storage area. In the case of optic signals, for example, a light color depending on the distance of the hand and/or the arm or the object to the storage area may vary. As an alternative, the signaling unit can emit light impulses of a same light color, a time interval of which is varied depending on the distance of the hand and/or the arm or the object to the storage area.

Another advantageous embodiment provides for the signaling unit having at least one display unit that is set up to display an image representation, which is formed from optic signals, of the captured area of the passenger interior. Thereby, the signaling unit is set up to emit optic signals. The display unit can be arranged in an area of the motor vehicle situated on a front side in front of a head of the driver. In this way, the driver can orient his/her sight forwards, as is customary when driving a motor vehicle, and preferably, simultaneously perceive a situation with regard to upcoming traffic and image representation. Thereby, an image representation is to be understood as a representation that changes like a film over the course of time, preferably in real-time, so that the image representation reflects a current situation within a region captured by the sensor unit. The image representation can contain virtual components to create an augmented reality, such as arrows for example, distance information, regions highlighted with colors, such as, for example, the hand of the driver, an object located in the storage area or in the hand of the driver and/or the storage area or the like. The image representation can be a view of at least one area of the passenger interior.

In accordance with a further advantageous embodiment, the display unit comprises at least one image projection unit, with which the image representation of the captured area of the passenger interior can be projected onto a component of the motor vehicle. For example, a display unit can be designed as a head-up display, where the image representation is projected onto an inside of the front windshield of the motor vehicle. Alternatively, the image representation can be projected to at least one section of a rear-view mirror of a motor vehicle.

It is advantageous if the display unit is designed as a screen arranged within a dashboard or in a center console of the motor vehicle. The screen can be a monitor or a touchscreen of an infotainment system of the motor vehicle. Alternatively, the screen can be arranged on the rear-view mirrors of the motor vehicle.

Furthermore, it is advantageous if the display unit is designed as smart glasses. With smart glasses, the motor vehicle may remain unmodified to create and organize a display unit. Instead, the image representation is illustrated on the smart glasses, also called data glasses. The smart glasses can be wirelessly connected to the evaluation unit in order to be able to be controlled by the evaluation unit.

In accordance with another advantageous embodiment, the evaluation unit is set up to control the display unit in such a way that a displayed size of an image range comprising the storage area is varied depending on a current distance of the hand and/or the arm of the driver to the storage area. Thereby, an image range comprising the storage area is larger if the hand or the arm of the driver gets closer to the storage area, and smaller if the hand or the arm travel away from the storage area. Due to enlarging and zooming the image range, attentiveness of the driver is specifically directed onto a relevant area between the hand and the arm of the driver and the storage area, while sections of the passenger interior located further away from the storage area are not displayed so that this cannot impair concentration of the driver.

In accordance with another advantageous embodiment, the system has at least one activation unit to activate the sensor unit and/or the evaluation unit, wherein the activation unit is set up to activate the sensor unit and/or the evaluation unit when a captured speed of the motor vehicle exceeds a predefined limit value and/or if an activation command of the driver is detected via a man/machine interface. During the other periods, the sensor unit and/or the evaluation unit can stay deactivated, which reduces the energy consumption of the system in a favorable manner. The activation unit can be set up to activate the sensor unit and/or the evaluation unit if the current speed of the motor vehicle exceeds a predefined limit value after a starting procedure of the motor vehicle for the first time. Alternatively, the sensor unit and/or the evaluation unit can be activated without interruption after starting the motor vehicle. The man-machine interface can be designed as a control element, in particular, as a button, as a control panel with operating elements, as a touchscreen or voice control unit.

Another advantageous embodiment provides for the evaluation unit being set up to detect data concerning a position and/or a shape of the storage area from sensor signals and to take this data into account when controlling the signaling unit. With this, the system can be freely configured and be easily adapted to the respective embodiment of a passenger interior. The data concerning a position and/or a shape of the storage area may not be provided to the system in advance by inputting data. Instead, the system can automatically collect this data, for example, in the case of starting the system in a motor vehicle and save the data for further use. With this, the system can be used for all motor vehicle models, independent of their respective passenger-interior configuration. To determine data on the position and/or the shape of the storage area from the sensor signals, the evaluation unit can have at least one image processing algorithm that is trained to identify data on the position and/or the shape of at least one storage area, for example, on the inside of a door, on the dashboard, on the center console or on a component lying between the front seats.

It is advantageous if the system has at least one electronic information storage unit, in which motor vehicle-specific data concerning a position and/or a shape of a storage area are stored, wherein the evaluation unit is set up to take this data into account when controlling the signaling unit. The motor vehicle-specific data can be loaded in the electronic information storage system before starting the system and be stored there. This data is specifically for a motor vehicle model or a certain motor vehicle platform. The data contains coordinates of storage areas, wherein the coordinates a well-known and do not change with time.

In accordance with a further advantageous embodiment, the evaluation unit is set up to determine if an object is in the hand of the driver by sensor signals. For this purpose, the evaluation unit can have an image processing algorithm that is suited to detect if an object is in the hand of the driver or not. Preferably, the evaluation unit can detect that an object is in the driver's hand independently of a respective shape of the object located within the driver's hand. For this purpose, the evaluation unit can be set up to detect if any shape is available and/or if the hand of the driver has a certain structure, which is, for example, determined from a respective finger position and respective finger angles. If no object is in the driver's hand, the evaluation unit can deduce that the driver would like to take an object located in the storage area into his/her hand. As soon as the evaluation unit has detected the situation, it can activate the signaling unit in order to support the driver in grasping the object. As soon as the evaluation unit detects that there is an object in the hand of the driver, the evaluation unit can deactivate the signaling unit. On the contrary, if an object located in the hand moving towards the storage area or if the hand holding the object is located within the environment of the storage area for a predetermined period of time, the evaluation unit can deduce that the driver would like to store or set down the object in the storage area. As soon as the evaluation unit has detected this situation, the evaluation unit can activate the signaling unit in order to support the driver in storing or setting the object in the storage area. Based upon the shape of the hand, as soon as the evaluation unit detects that the object is no longer in the driver's hand, the evaluation unit can deactivate the signaling unit.

In accordance with another advantageous embodiment, the evaluation unit is set up to control the display unit in such a way that the hand of the driver and the storage area are highlighted on a visual level in the image representation. This highlighting on a visual level can take place by color variation and/or a brightness variation. Alternatively or in addition, other structures contained within the image representation can be optically suppressed, in which the hand or the storage device also appear to be highlighted. The visual highlighting of the hand and the storage area has the effect that the driver can concentrate on important components, hand and storage area, and is not distracted by other structures contained in the image representation.

It is furthermore advantageous if the evaluation unit is set up to determine a virtual path of movement of the hand and the arm from a captured movement of the hand and/or the arm of the driver, as well as control the display unit in such a way that the image representation contains the virtual path of movement. The driver can find out from the image representation early on if his/her hand specifically moves towards the storage area or not, which facilitates and accelerates the movement of the hand towards the storage area so that the driver has to spend the least amount of time possible to set down or store an object in the storage area or to take it from the storage area. Thus, attention of the driver is impaired as little as possible.

In accordance with another advantageous embodiment, the system comprises at least one apparatus to monitor attentiveness of the driver, wherein the apparatus is set up to generate an activation signal and send it to the sensor unit and/or the evaluation unit if the apparatus detects that the driver is inattentive. The apparatus can, for example, monitor the position of the head and/or the position of the eyes of the driver in order to be able to deduce if the driver is attentive or not with regard to the respective driving situation. If the apparatus detects that the driver is inattentive or not suitably attentive, the apparatus emits at least one activation signal to the sensor unit and/or the evaluation unit in order to start the support process of the system. In a driving situation, the driver assistance system can refrain from activating the sensor unit and/or the evaluation unit and transfer the motor vehicle into a safe status, for example, by driving the motor vehicle onto an emergency lane and stopping there.

A method according to the disclosure to support a handling of an object, which is not connected to the motor vehicle, located on an inside of a passenger interior of a motor vehicle comprises the steps: Detecting a distance of the object to at least one storage area within the passenger interior and/or of at least one area of the passenger interior, wherein the area has at least one storage area to store at least one object. Detecting if a hand and/or arm of the driver moves towards the storage area and/or if the hand/or arm of the driver is located, for a predefined period of time, within a an environment comprising the storage area of a predefined size; and emitting optic, acoustic and/or haptic signals within the passenger interior, if the hand and/or the arm of the driver moves towards the storage area and/or if the hand and/or the arm of the driver is located within the environment comprising the storage area of a predefined size.

The above-mentioned advantages with reference to the system are associated with the method accordingly. In particular, the system according to one of the above-mentioned embodiments or any combination of at least two of these embodiments with each other can be used to carry out the method.

In accordance with an advantageous embodiment, the emitted signals may be varied depending on a distance of the hand and/or the arm of the driver or the object to the storage area. The advantages mentioned above with reference to the corresponding environment are associated with this embodiment accordingly.

Another exemplary embodiment provides that a displayed size of an image range of an image representation formed by optic signals comprising the storage area is varied depending on a current distance of the hand and/or the arm of the driver to the storage area. The advantages mentioned above with reference to the corresponding environment are associated with this embodiment accordingly.

Furthermore, it is advantageous if detecting at least one area of a passenger interior takes place when a detected speed of the motor vehicle exceeds a predefined limit value and/or if an activation command of the driver is detected via a man/machine interface. The advantages mentioned above with reference to the corresponding environment are associated with this embodiment accordingly.

In accordance with another advantageous embodiment, data concerning a position and/or a shape of the storage area are determined from detecting at least one area of a passenger interior and taken into consideration during the emission of signals. The advantages mentioned above with reference to the corresponding environment are associated with this embodiment accordingly.

It is advantageous if, when emitting the signals, to take stored motor vehicle-specific data concerning a position and/or a shape of the storage area into account. The advantages mentioned above with reference to the corresponding environment are associated with this embodiment accordingly.

In accordance with a further advantageous embodiment, it is determined if there is an object in the hand of the driver. The advantages mentioned above with reference to the corresponding environment are associated with this embodiment accordingly.

Another advantageous embodiment provides for the hand of the driver and the storage area to be highlighted on a visual level in one image representation formed by optic signals. The advantages mentioned above with reference to the corresponding environment are associated with this embodiment accordingly.

In accordance with another advantageous embodiment, a virtual path of movement of the hand or the arm is detected from a detected movement of the hand and/or the arm of the driver and the virtual path of movement is indicated in an image representation formed by optic signals. The advantages mentioned above with reference to the corresponding environment are associated with this embodiment accordingly.

It is advantageous if the attention of the driver is monitored, wherein capturing the area of passenger interior occurs when it is detected that the driver is not being attentive. The advantages mentioned above with reference to the corresponding environment are associated with this embodiment accordingly.

A motor vehicle according to the disclosure comprises at least one system according to one of the aforementioned embodiments or any combination of at least two of these embodiment with one another.

The above-mentioned advantages with reference to the system and the method are associated with the motor vehicle accordingly. The motor vehicle can be a car or a truck.

In the following, the disclosure is explained as an example using the preferred embodiments taking the enclosed Figures into account, wherein the following features mentioned can be respectively taken as they are or in a different combination of at least two of these embodiments with one another to be able to represent an advantageous or further developed aspect of the disclosure.

### BRIEF DESCRIPTION OF THE DRAWINGS

FIG. 1 is a schematic illustration of an exemplary embodiment for a system according to the disclosure; and

FIG. 2 is a flowchart of an exemplary embodiment for a method according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

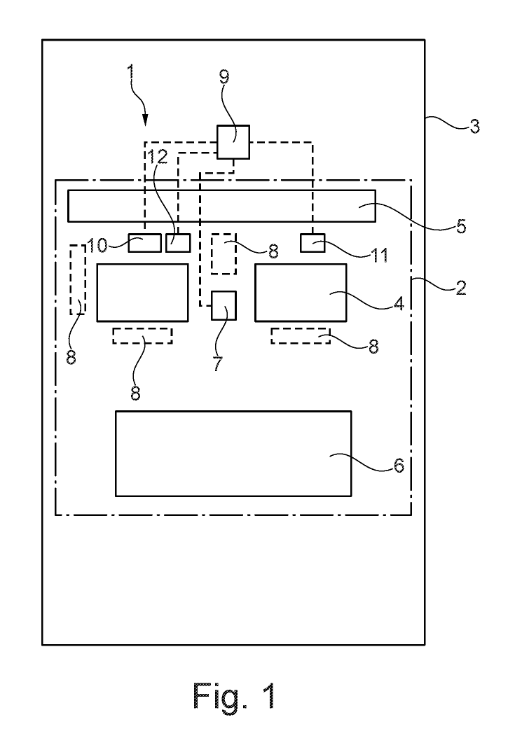

FIG. 1 shows a schematic representation of an exemplary embodiment for a system 1 according to the disclosure to support the handling of an object 13 located within a passenger interior 2 of a motor vehicle 3 and not connected to the motor vehicle 3. Within the passenger interior 2, there are two front seats 4, a dashboard 5 and a backseat 6.

The system 1 comprises a sensor unit 7 arranged on the motor vehicle 3, which is set to up to detect a distance 14 of an object 13 to at least one storage area 8 available within the passenger interior 2 and/or to detect at least one area of the passenger interior 2 or the entire passenger interior 2, wherein the detected area has at least one storage area 8 to store the object 13. The sensor unit 7 may be a camera (not shown) that is arranged within an upper area of the passenger interior 2.

Furthermore, the system 1 comprises at least one evaluation unit 9, which is set up to receive and process sensor signals generated by the sensor unit 7, and a signaling unit 10 that can be controlled using the evaluation unit 9, which is set up to emit optic, acoustic and/or haptic signals within the passenger interior 2.

The evaluation unit 9 is set up to determine from the sensor signals if a hand (not shown) and/or an arm (not shown) of the driver (not shown) moves towards the storage area 8 and/or if the hand and/or the arm of the driver is located, for a predetermined period of time, within an environment comprising the respective storage area 8 having a predetermined size of the respective storage area 8. Furthermore, the evaluation unit 9 is set up to activate the signaling unit 10 if the hand and/or the arm of the driver moves towards the respective storage area 8 and/or if the hand/or the arm of the driver is located within an environment comprising the respective storage area 8 having a predetermined size for a predetermined period of time. Thereby, the evaluation unit 9 is set up to control the activated signaling unit 10 in such a way that signals emitted from the signaling unit 10 are varied depending on a distance of the hand and/or of the arm of the driver or the object to the respective storage area 8. The evaluation unit 9 is set up to determine if an object is in the hand of the driver using the sensor signals.

The signaling unit 10 can have at least one display unit (not shown) that is set up to display an image representation, which is formed from optic signals, of the captured area of the passenger interior 2. The display unit can have an image projection unit (not shown), with which the image representation of the detected area of the passenger interior 2 can be projected onto a component (not shown), particularly on a front windshield (not shown), of the motor vehicle 3. Alternatively, the display unit can be designed as a screen (not shown) arranged in the dashboard 5 or a center console (not shown) of the motor vehicle 3. Alternatively, the display unit is formed by smart glasses (not shown). The evaluation unit 9 can be set up to control the display unit in such a way that a displayed size of an image range comprising the respective storage area 8 is varied depending on a current distance of the hand and/or the arm of the driver to the respective storage area 8.

Furthermore, the evaluation unit 9 can be set up to control the display unit in such a way that the hand of the driver and the storage area 8 are highlighted on a visual level. In addition, the evaluation unit 9 can be set up to determine a virtual path of movement of the hand and the arm from a captured movement of the hand and/or the arm of the driver as well as control the display unit in such a way that the image representation contains the virtual path of movement.

The evaluation unit 9 can be set up to determine data concerning a position, in particular, location coordinates and/or a shape of the respective storage area 8 and take these data into account when controlling the signaling unit 10. As an alternative, the system 1 can have an electronic information storage unit (not shown), in which motor vehicle-relevant data concerning the position and/or the shape of the respective storage area 8 is stored, wherein the evaluation unit 9 is set up to take these data into account when controlling the signaling unit 10.

The system 1 comprises an activation unit 11 to activate the sensor unit 7 and/or the evaluation unit 9, wherein the activation unit 11 is set up to activate the sensor unit 7 and/or the evaluation unit 9 if a detected speed of the motor vehicle 3 exceeds a predetermined limit value, particularly for the first time after starting the motor vehicle and/or if an activation command of the driver via a man/machine interface (not shown) is detected.

Furthermore, the system 1 comprises an apparatus 12 to monitor attentiveness of the driver, whereby the apparatus 12 is set up to generate an activation signal and send it to the sensor unit 7 and/or to the evaluation unit 9 if the apparatus 12 detects that the driver is inattentive.

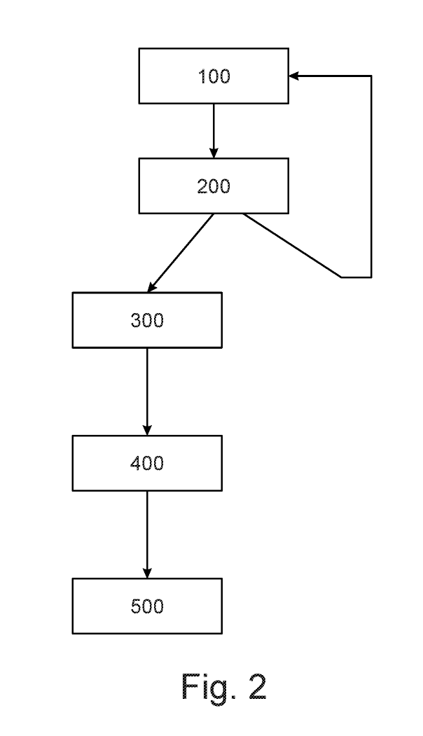

FIG. 2 shows a flowchart of an exemplary embodiment for a method according to the disclosure to support handing of an object located within the passenger interior of a motor vehicle and not connected to the motor vehicle. The system shown in FIG. 1 can be used to carry out the method.

In process step 100, at least one area of the passenger interior or the entire passenger interior is captured by a camera, wherein the area of the passenger interior has at least one storage area to store at least one object.

In process step 200, it is detected if a hand and/or an arm of a driver of the motor vehicle moves towards the storage area and/or if the hand and/or arm of the driver is located within an environment comprising the storage area having a predetermined size for a predetermined period of time.

If the hand and/or the arm of the driver moves towards the storage area and/or if the hand and/or the arm of the driver is located within the environment comprising the storage area of a predetermined size for a predetermined period of time, in process step 300, an optic, acoustic and/or haptic signal is emitted within the passenger interior. The emitted signals may be varied depending on a distance of the hand and/or the arm of the driver to the storage area. If the hand and/or the arm of the driver does not move towards the storage area and/or if the hand and/or the arm of the driver is not located within the environment comprising the storage area of a predetermined size for a predetermined period of time, a skip is made to process step 100.

If optic signals are emitted in process step 300 in the form of an image representation formed by the detected area of the passenger interior, a portrayed size of an image range comprising the storage area can vary depending on a current distance of the hand and/or the arm of the driver to the storage area. In the image representation, the hand of the driver and the storage area can be highlighted on a visual level.

The detection of the at least one area of the passenger interior can take place in process step 100 when a detected speed of the motor vehicle exceeds a predefined limit value and/or if an activation command of the driver is detected via a man/machine interface. In process step 100, data concerning a position and/or a shape of the storage area can be determined from detection of at least one area of the passenger interior and be taken into consideration during the emission of signals. As an alternative, in process step 100, when the emitting the signals, stored motor vehicle-specific data concerning a position and/or a shape of the storage area can be taken into account.

At a process step 200, it is additionally determined if an object is in the hand of the driver. In addition, in process step 200, a virtual path of movement of the hand or the arm can be determined from a detected movement of the hand and/or the arm of the driver and the virtual path of movement can be displaced in the image representation.

In process step 400, it is detected if the driver has grasped the object located in the storage area with his/her hand or if the driver has stored or placed an object located in his/her hand into the storage area. If this is the case, in process step 500, the support of handling the object ends and the emission of the signals is stopped then a skip is made to process step 100.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle system comprising:
a sensor configured to detect a distance of an object to a storage area within an interior;
an evaluation unit configured to process signals generated by the sensor to determine if a driver hand moves towards the storage area and is located, for a predetermined time period, within the storage area; and
a signaling unit configured to emit haptic signals within the interior responsive to being activated by the evaluation unit.

2. The system as claimed in claim 1, wherein the evaluation unit is configured to control an activated signaling unit such that signals emitted from the signaling unit are varied depending on a distance of the driver hand to the storage area.

3. The system as claimed in claim 1, wherein the signaling unit includes at least one display unit configured to display an image representation, which is formed from optic signals, of a captured area of the passenger interior.

4. The system as claimed in claim 3, wherein the display unit has at least one image projection unit configured to project the image representation of the captured area of the passenger interior onto a component of the motor vehicle.

5. The system as claimed in claim 3, wherein the display unit is a screen arranged in a dashboard.

6. The system as claimed in claim 3, wherein the display unit is formed by smart glasses.

7. The system as claimed in claim 3, wherein the evaluation unit is configured to control the display unit such that a displayed size of an image range of the storage area is varied depending on a current distance of the driver hand to the storage area.

8. The system as claimed in claim 1 further comprising at least one activation unit to activate the sensor unit and the evaluation unit, wherein the activation unit is configured to activate the sensor unit and the evaluation unit responsive to a detected vehicle speed exceeding a predetermined limit value or if an activation command via an interface is detected.

9. The system as claimed in claim 1, wherein the evaluation unit is configured to determine a position and shape of the storage area when controlling the signaling unit.

10. The system as claimed in claim 1, wherein the evaluation unit is configured to determine if an object is in the driver hand from the sensor signals.

11. The system as claimed in claim 3, wherein the evaluation unit is configured to control the display unit such that the driver hand and the storage area are highlighted on a visual level.

12. The system as claimed in claim 3, wherein the evaluation unit is configured to determine a virtual movement path of the driver hand from a captured movement of the driver hand and control the display unit such that the image representation contains the virtual movement path.

13. A method to support handling of an object within a motor vehicle that is not connected to the motor vehicle comprising:
detecting a distance of an object to at least one storage area available within a passenger interior;
determining if a driver hand moves towards the storage area and is located, for predetermined period of time, in the storage area; and
emitting optic, acoustic and haptic signals within the passenger interior if the driver hand moves towards the storage area and if the driver hand is located within a predetermined size of the storage area for the predetermined period of time.

14. The method as claimed in claim 13 further comprising varying the emitted signals depending on the distance of the driver hand to the storage area.

15. The method as claimed in claim 13 further comprising varying a displayed size of an image range of an image representation formed from optic signals depending on a current distance of the driver hand to the storage area.

16. The method as claimed in claim 13, wherein detecting the distance of the object to the storage area occurs when a detected vehicle speed exceeds a predefined limit and if an activation command is detected via an interface.

17. The method as claimed in claim 13 further comprising determining a position and a shape of the storage area , which are taken into consideration during the emitting.

18. The method as claimed in claim 13 further comprising determining if an object is in the driver hand.

19. The method as claimed in claim 13 further comprising highlighting the driver hand and the storage area on a visual level in an image representation formed by optic signals.

20. The method as claimed in claim 13 further comprising detecting a virtual path of movement of the driver hand from a detected movement of the driver hand and displaying the virtual path of movement in an image representation formed by optic signals.
